(19) United States
(12) Patent Application Publication
(10) Pub. No.: US 2007/0058131 A1
(43) Pub. Date: Mar. 15, 2007

(54) Tinted contact lenses with three-dimensional iris patterns

(76) Inventors: Jack W. Bowers, Jacksonville, FL (US); Karin D. McCarthy, Ponte Vedra Beach, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/227,700

(22) Filed: Sep. 15, 2005

(51) Int. Cl. G02C 7/04

(52) U.S. Cl. 351/162

(57) ABSTRACT

The invention provides tinted contact lenses that have a pattern that has a three-dimensional appearance providing depth to the pattern and a more natural appearance to the pattern when the lens is worn on-eye.

### FIELD OF THE INVENTION

The invention relates to tinted contact lenses. In particular, the invention provides contact lenses with iris patterns that either enhance or change the color of a lens wearer's iris and which patterns have an appearance of depth.

### BACKGROUND OF THE INVENTION

The use of tinted, or colored, contact lenses to either or both alter the natural color of the iris and to mask ophthalmic abnormalities is well known. Typically, these lenses use either or both opaque and translucent colors to change the color of an iris, as for example, from brown to blue. Additionally, tinted lenses have been manufactured that attempt to enhance the color of a dark-eyed person without changing the color of the iris. The conventional tinted lenses are disadvantageous in that they lack the three-dimensional appearance of the natural iris. This results in a flat, unnatural appearance when the lens is worn on-eye.

### BRIEF DESCRIPTION OF THE DRAWINGS

FIG. 1 is one embodiment of the invention.

FIG. 2 is an enlarged view of a portion of FIG. 1.

FIG. 3 is a second embodiment of the invention.

FIG. 4 is a third embodiment of the invention.

FIG. 5 is a fourth embodiment of the invention.

### DETAILED DESCRIPTION OF THE INVENTION AND PREFERRED EMBODIMENTS

The invention provides tinted contact lenses, and methods for their manufacture, that enhance the color of the lens wearer's iris. The lenses of the invention have a pattern that has a three-dimensional appearance providing depth to the pattern and a more natural appearance to the pattern when the lens is worn on-eye. The lenses of the invention will find utility as cosmetic lenses for either or both enhancing an individual's iris or changing the color of the iris.

In one embodiment, the invention provides a contact lens having a pattern comprising, consisting essentially of, and consisting of a plurality of curved elements.

It is a discovery of the invention that an appearance of depth may be imparted to a tinted pattern of a contact lens by using curved elements. The curved elements may be of any suitable width and length. Additionally, the curved elements may themselves be composed of a plurality of geometrically-shaped elements including, without limitation dots shaped as spheres, ellipses, or the like, non-geometrically-shaped elements, or combinations thereof. Alternatively, each of the curved elements may be a single, elongated geometrically-shaped element including, without limitation, a stria, or a non-geometrically-shaped element including, without limitation, a diamond or arbitrary shape. The curved elements may be of uniform or varying shapes and sizes and preferably each are about 0.10 to about 4.0 mm, more preferably 0.50 to about 2.5 mm in length and 0.15 to 0.25 mm in width.

The curved elements extend inwardly from the outermost border of the iris portion of the lens, meaning the portion of the lens that overlies the iris when the lens is on-eye and centered, toward the geometric center of the lens. Preferably, the curved elements do not extend over the entire iris portion of the lens. Rather, preferably the curved elements extend inwardly from the outermost edge of the iris portion so that the innermost edge of the elements is located at about 5.0 mm or more, more preferably about 7 mm or more from the geometric center of the lens.

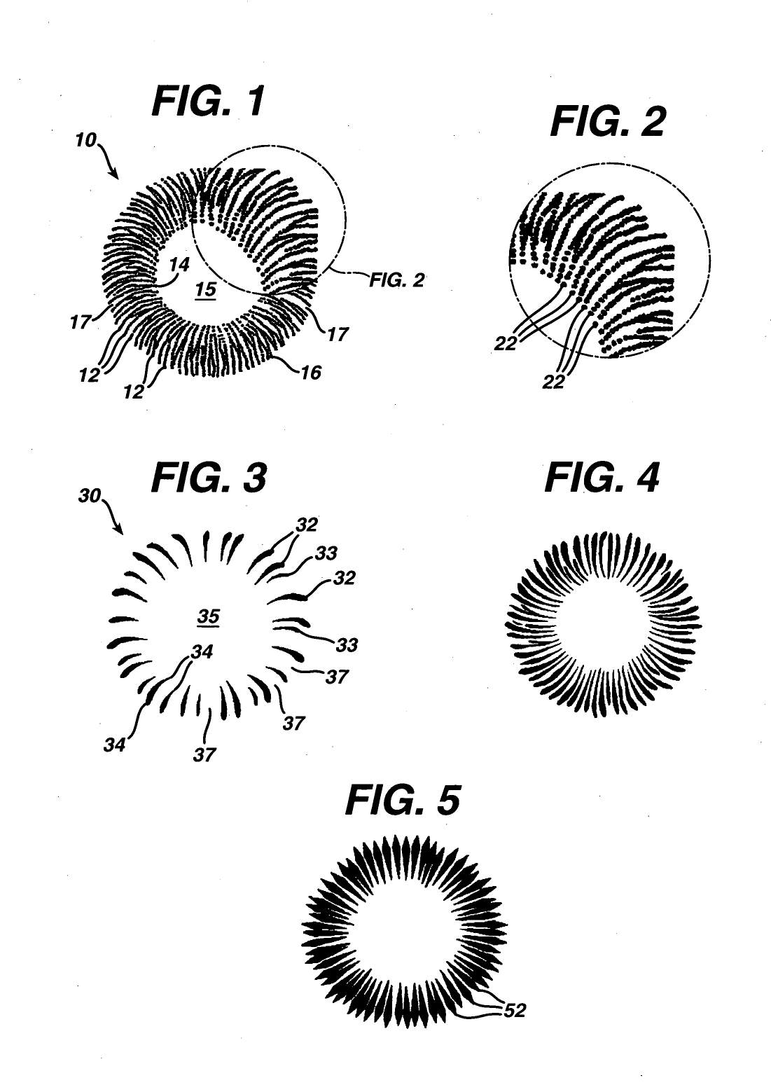

In FIG. 1 is shown one embodiment of a pattern 10 of the invention. In this embodiment, from the outermost border 16 of the iris portion and extending inwardly towards the portion of the pattern that will be at the geometric center of the lens are a plurality of curved elements 12, the innermost border 14 of which lies at a diameter of about 5.5 mm from the geometric center of the lens. As shown in FIG. 2, an enlarged view of a portion of the pattern of FIG. 1, each of the curved elements is composed of a plurality of dots 22. The dots may be of any suitable size and preferably are from about 0.09 to about 0.175 mm in diameter.

Although all of the curved elements are generally similarly configured, preferably no one of the curved elements is exactly the same as another. The curved elements are interspersed by spaces 17 in which spaces there are no elements. Spaces 17 are also generally all similarly configured, but preferably no one of the spaces is of the exact same configuration as any of the other of the spaces or spokes. Area 15 is a region in which there are no pattern elements, which area as shown, will partially compose the iris portion as well as the whole of the pupil portion, or portion of the lens that overlies the wearer's pupil while the lens is on-eye and centered. As shown, area 15 is clear, but it may be translucently or opaquely colored as well. Innermost border 14 as shown is of an even, regular shape, but may be an uneven, irregular border.

In FIG. 3 is shown an alternative curved element pattern 30. In this embodiment, beginning at the outermost border 34 of the iris portion and extending inwardly is a plurality of curved elements that are formed by striae that are in elongated, tear-drop form. Some curved elements 32 are longer than other of the curved elements 33. The curved elements are interspersed by spaces 37 in which spaces, as shown, there are no elements. However, as an alternative embodiment, any number of additional, curved or non-curved elements of geometric or non-geometric shape may be added into spaces 37. The innermost border 34 of the curved elements, as shown, is of an uneven, irregular shape, but may be made so as to form an even border. Area 35 is a region in which there are no pattern elements, which area will partially compose the iris portion as well as all of the pupil portion of the lens. In FIG. 4 is shown an alternative embodiment of the design of FIG. 3 in which an additional number of striae are used.

In FIG. 5 is shown yet another pattern of the invention. In this embodiment, beginning at the outermost border of the iris portion and extending inwardly are a plurality of elongated, diamond-shaped elements 52. As shown, the elements are all of substantially the same length and width, but as an alternative may be of varying lengths and widths. Additionally, although the elements are shown spaced at substantially regular intervals from one another, they may be irregularly spaced as well.

In all of the patterns of the invention the curved elements extend inwardly to the geometric center of the lens. Preferably, the innermost border of the elements, or edge relative to the geometric center of the lens, is located at about 5.0 mm or greater, preferably about 7 mm or greater from the geometric center of the lens.

In addition to the curved elements, the patterns of the invention may include any of a number of additional components. The additional components may include, without limitation, geometric structures, such as dots and lines, or fanciful structures including, without limitation, striae, feather-like shapes, and the like, and combinations thereof. A limbal ring may be added to surround the outermost periphery of the pattern. By “limbal ring” is meant an annular band of color that, when the lens is on-eye and centered, partially or substantially completely overlies the lens wearer's limbal region, or the junction of the sclera with the cornea. Preferably, the limbal ring substantially completely overlies the wearer's limbal region. The innermost border, or edge closest to the geometric center of the lens, of the limbal ring may be at a diameter of about 8 mm to about 12 mm, preferably about 9 to about 11 mm, from the lens geometric center. The ring may be of any suitable width and preferably is about 0.5 to about 2.5 mm in width, more preferably about 0.75 to about 1.25 mm in width.

In any of the patterns of the invention, the pupil portion preferably is clear. However, the pupil portion may be an area of translucent or opaque color or any combination of opaque and translucent colors.

Preferably, the curved elements are of an opaque color. Alternatively, the curved elements may be translucent, or a combination of translucent and opaque curved elements may be used depending on the desired on-eye result. For purposes of the invention, by “translucent” is meant a color that permits an average light transmittance (% T) in the 380 to 780 nm range of about 60 to about 99%, preferably about 65 to about 85% T. By “opaque” is meant a color that permits an average light transmittance (% T) in the 380 to 780 nm range of 0 to about 55, preferably 7 to about 50% T. Similarly, additional elements of the pattern may be opaque, translucent or a combination thereof. The color of the curved elements and other pattern elements may be substantially the same as, or complementary to, each other. Preferably, all elements of the pattern are of the same color and the pupil portion is clear, meaning that it is colorless.

The color selected for each of the curved elements and other pattern elements will be determined by the natural color of the lens wearer's iris and the enhancement or color change desired. Thus, elements may be any color including, without limitation, any of a variety of hues and chromas of blue, green, gray, brown, black yellow, red, or combinations thereof. Preferred colors for the limbal ring include, without limitation, any of the various hues and chromas of black, brown and gray.

The elements, may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange # 1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a pre-polymer, or binding polymer, and a solvent to form the colorant used to produce the translucent and opaque layers used in the lenses of the invention. Other additives useful in contact lens colorants also may be used. The binding polymers, solvents, and other additives useful in the color layers of the invention are known and either commercially available or methods for their making are known.

The curved elements, and any additional pattern elements, may be incorporated into a contact lens by any convenient method including, without limitation, printing on one or more surfaces of a lens or printing onto one or more surfaces of a mold into which a lens forming material will be deposited and cured. In a preferred method for forming lenses incorporating the designs of the invention, a thermoplastic optical mold, made from any suitable material including, without limitation, cyclic polyolefins and polyolefins such as polypropylene or polystyrene resin is used. The elements are deposited onto the desired portion of the molding surface of the mold. By “molding surface” is meant the surface of a mold or mold half used to form a surface of a lens. Preferably, the deposition is carried out by pad printing as follows.

A metal plate, preferably made from steel and more preferably from stainless steel, is covered with a photo resist material that is capable of becoming water insoluble once cured. The elements are selected or designed and then reduced to the desired size using any of a number of techniques such as photographic techniques, placed over the metal plate, and the photo resist material is cured.

The plate is subsequently washed with an aqueous solution and the resulting image is etched into the plate to a suitable depth, for example about 20 microns. A colorant containing a binding polymer, solvent, and pigment or dye is then deposited onto the elements to fill the depressions with colorant. A silicon pad of a geometry suitable for use in printing on the surface and varying hardness, generally about 1 to about 10, is pressed against the image on the plate to remove the colorant and the colorant is then dried slightly by evaporation of the solvent. The pad is then pressed against the molding surface of an optical mold. The mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

In a preferred embodiment, a clear, pre-polymer layer is used, which pre-polymer layer overlays at least the pattern elements and preferably forms the entirety of the lens' outermost surface. The pre-polymer may be any polymer that is capable of dispersing the pigment and any opacifying agent used and may be applied over the pattern elements once the elements are incorporated into the lens. Alternatively, the pre-polymer layer may be printed onto the molding surface of a lens mold prior to application of the pattern elements to the mold.

The invention may be used to provide tinted hard or soft contact lenses made of any known lens-forming material, or material suitable for manufacturing such lenses. Preferably, the lenses of the invention are soft contact lenses, the material selected for forming the lenses being any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the lens is made from a material containing a siloxane functionality, including, without limitation, polydimethyl siloxane macromers, methacryloxypropyl polyalkyl siloxanes, and mixtures thereof, a silicone hydrogel or a hydrogel made of monomers containing hydroxy groups, carboxyl groups, or both and combinations thereof. Materials for making soft contact lenses are well known and commercially available. Preferably, the lens material is acquafilcon, etafilcon, genfilcon, lenefilcon, balafilcon, lotrafilcon, or galyfilcon.

What is claimed is:

1. A contact lens, comprising a pattern comprising a plurality of curved elements.

2. The contact lens of claim 1, wherein each of the curved elements is comprised of a plurality of geometrically-shaped elements.

3. The contact lens of claim 2, wherein the geometrically shaped-elements are selected from the group consisting of spheres, ellipses, and combinations thereof.

4. The contact lens of claim 1, wherein each of the curved elements is comprised of a plurality of non-geometrically-shaped elements.

5. The contact lens of claim 4, wherein the non-geometrically shaped-elements are selected from the group consisting of striae, diamond-shapes, arbitrary shapes, and combinations thereof.

6. The contact lens of claim 1, wherein the elements are of a substantially uniform shape and size.

7. The contact lens of claim 2, wherein the elements are of a substantially uniform shape and size.

8. The contact lens of claim 4, wherein the elements are of a substantially uniform shape and size.

9. The contact lens of claim 1, wherein the elements are of varying shapes and sizes.

10. The contact lens of claim 2, wherein the elements are of varying shapes and sizes.

11. The contact lens of claim 4, wherein the elements are of varying shapes and sizes.

12. The contact lens of claim 1, wherein each of the elements is about 0.10 to about 4.0 mm in length and 0.15 to 0.25 mm in width.

13. The contact lens of claim 1, further comprising a limbal ring.

14. The contact lens of claim 2, further comprising a limbal ring.

15. The contact lens of claim 4, further comprising a limbal ring.

16. A method of manufacturing a contact lens, comprising the steps of providing a pattern comprising a plurality of curved elements and incorporating the curved elements into the contact lens.
